(19) United States
(12) Patent Application Publication
(10) Pub. No.: US 2008/0206715 A1
(43) Pub. Date: Aug. 28, 2008

(54) COLOR CHANGING DENTAL ADHESIVE COMPOSITIONS AND RELATED METHODS AND KITS

(75) Inventors: Andy T. Kawamoto, Sandy, UT (US); Gordon Kennard, Cedar Hills, UT (US); Jeff Wagner, Sandy, UT (US)

Correspondence Address: WORKMAN NYDEGGER, 60 EAST SOUTH TEMPLE, 1000 EAGLE GATE TOWER, SALT LAKE CITY, UT, 84111, US

(73) Assignee: Ultradent Products, Inc., South Jordan, UT (US)

(21) Appl. No.: 11/680,379

(22) Filed: Feb. 28, 2007

(51) Int. Cl. A61C 8/00

(52) U.S. Cl. 433/226

(57) ABSTRACT

Methods, compositions, and kits for use in facilitating detection and removal of dental adhesives while minimizing and/or eliminating removal of adjacent tooth tissue. A pH sensitive color changing component (i.e., an acid/base indicator) is included within a dental adhesive composition or an activating wash composition. The adhesive composition is used to bond a dental appliance (e.g., a provisional restorative appliance or an orthodontic bracket) to a tooth. When it becomes necessary to remove the dental appliance, selective removal of the dental adhesive while minimizing and/or eliminating removal of enamel or other adjacent tooth tissue are facilitated because of the inclusion of a pH sensitive color-changing component within the dental adhesive or activating wash composition. The adhesive changes from a first color having low contrast relative to adjacent tooth tissue to a second color having greater contrast relative to adjacent tooth tissue upon application of the activating wash.

### BACKGROUND OF THE INVENTION

1. The Field of the Invention

The present invention relates to dental adhesive compositions. More particularly, the invention relates to pH sensitive color changing dental adhesive compositions and related methods and kits for use in highlighting cured adhesive that remains adhered to a tooth so as to facilitate its detection and removal.

2. The Relevant Technology

When a dental practitioner performs a procedure requiring placement of a dental appliance (e.g., a veneer or crown), a permanent appliance is typically custom fabricated at a remote dental lab specializing in custom appliance fabrication. Because permanent appliances typically take up to several weeks to prepare, the practitioner will often fit a provisional appliance to the person's tooth until a permanent appliance is ready. The provisional appliance is intended to be a temporary prosthesis until a permanent appliance can be ordered and fabricated.

Because the provisional appliance is only intended for temporary use, it is typically bonded to the tooth using a relatively weak (i.e., low bond strength) temporary dental adhesive. Temporary cements can provide sufficient compressive strength and bonding strength to allow the patient to engage in typical use of their teeth (e.g., biting, chewing, etc.) but have sufficiently low bonding strength so as to facilitate easy removal of the provisional appliance by the practitioner when it is desired to replace the provisional appliance with the permanent appliance.

When removing the provisional appliance and temporary adhesive from the tooth, it is typically desirable to completely remove the adhesive so that a smooth bonding surface is made available for bonding the permanent appliance. Removal of the temporary adhesive is difficult when the adhesive is tooth-colored or colorless so as to be aesthetically acceptable to the patient. Low color contrast inhibits visual detection of temporary adhesive that may remain on the tooth. For example, when removing temporary adhesive in preparation to placing a veneer (e.g., porcelain or composite), flecks of tooth-colored or colorless adhesive of very low contrast are often still present on the tooth surface. Such flecks of raised material can cause a fragile veneer to crack during placement, resulting in waste, frustration, and delay to both the practitioner and the patient.

Furthermore, it is often difficult to remove just the adhering adhesive without removing enamel and/or other adjacent tooth tissue. It is desirable to minimize or eliminate removal of enamel and underlying tissue as the enamel is particularly important to the ability of the tooth to resist tooth decay, while underlying tissue is important to the structural integrity and overall health of the tooth.

Similarly, in orthodontic treatments, an adhesive is often used to bond the orthodontic brackets and/or other appliances to the tooth surface. Once treatment is complete the appliances are removed along with any adhesive (which is also often preferably clear and/or tooth-colored) that may remain adhered to the tooth surface. In removing the adhesive, it can be difficult to remove just the adhering adhesive without removing enamel and/or other tooth tissue because of the low visual contrast between the adhesive and the adjacent tooth tissue.

It would be an improvement in the art to provide methods, compositions, and kits which would facilitate detection and removal of all of the adhesive while minimizing and/or eliminating removal of adjacent tooth tissue (e.g., enamel).

### BRIEF SUMMARY OF THE INVENTION

The present invention is directed to methods, compositions, and kits for use in facilitating detection and efficient removal of dental adhesives while minimizing and/or eliminating removal of adjacent tooth tissue (e.g., enamel). A pH sensitive color-changing component (i.e., an acid/base indicator) is included within the dental adhesive composition or an activating wash composition. The adhesive composition is used to bond a dental appliance to a tooth. The dental appliance may comprise any restorative appliance (e.g., a veneer, crown, or other restorative appliance, particularly provisional restorative appliances) known in the art. In another embodiment, the appliance may comprise an orthodontic appliance (e.g., an orthodontic bracket) used during an orthodontic procedure. When it becomes necessary to remove the dental appliance and dental adhesive, minimizing and/or eliminating removal of enamel or other adjacent tooth tissue is facilitated because of the inclusion of a pH sensitive color-changing component within the dental adhesive or activating wash, which provides a color contrast between the adhesive and tooth tissue when the activating wash is applied over the cured dental adhesive.

In an exemplary inventive method, a tooth including a cured dental adhesive adhered thereto is provided. An activating wash composition (e.g., an aqueous solution having a basic or acidic pH—depending on the particular pH sensitive color-changing component employed and whether the pH sensitive color-changing component is within the adhesive or the wash) is applied to the tooth and adhered dental adhesive. A pH sensitive color-changing component is included within the activating wash or the dental adhesive. Upon contact of the activating wash with the dental adhesive, the pH sensitive color-changing component changes from a first color (e.g., colorless, white, or tooth-colored) having low contrast relative to adjacent tooth tissue to a second color (e.g., blue, red, yellow, or green) having a higher contrast relative to adjacent tooth tissue so as to highlight the remaining adhered dental adhesive. Such highlighting of the remaining adhered dental adhesive facilitates detection and removal of the adhesive, while minimizing and/or eliminating removal of adjacent enamel or other tooth tissue during the removal procedure.

For example, if the pH sensitive color-changing component is included within the adhesive, the activating wash composition is selected so as to have a pH that will cause the color of the pH sensitive color-changing component to change when the activating wash composition contacts the cured adhesive. Similarly, if the pH sensitive color-changing component is included within the activating wash composition, the dental adhesive advantageously provides a pH environment that will cause the color of the pH sensitive color-changing component to change when the activating wash composition contacts the cured adhesive. For example, one particularly preferred pH sensitive color-changing component is thymolphthalein, which changes from colorless to blue at a pH of about 9 to 10. When incorporating thymolphthalein within the dental adhesive, the activating wash composition preferably has a pH between about 9 and about 13, more preferably between about 10 and about 12. Similarly, when incorporating thymolphthalein within the activating wash composition, the dental adhesive may advantageously include a pH adjusting salt (e.g., sodium carbonate) or other component so as to provide a pH (e.g., between about 9 and about 13, preferably between about 10 and about 12) that will effect a change in color of the pH sensitive color-changing component from a first color to a second color.

An inventive kit includes a curable dental adhesive composition and an activating wash composition where a pH sensitive color-changing component is included within either the dental adhesive or the activating wash composition such that upon contact of the two parts of the kit (i.e., the activating wash and the dental adhesive) the pH of the part not including the pH sensitive color-changing component is such so as to cause a change in pH and resultant change in color of the pH sensitive color-changing component. In other words, if thymolphthalein is included as the pH sensitive color-changing component within the adhesive composition (which may typically have a somewhat acidic pH), the activating wash will be selected so as to have a pH (e.g., about 9 or greater) that will cause the thymolphthalein within the adhesive to change color upon contact of the wash with the adhesive. In an alternative, if thymolphthalein is included as the pH sensitive color-changing component within the activating wash composition (which may typically have a substantially neutral pH), the adhesive may incorporate a component (e.g., a basic salt) configured to raise the pH of the adhesive to a level (e.g., about 9 or greater) that will effect a color change upon contact of the adhesive with the activating wash.

The method and kit are particularly useful when removing a provisional veneer, crown (e.g., a full crown, half-crown, three-quarters crown, seven-eights crown, or other crown), inlay, onlay, or other provisional dental restorative appliance in preparation for installing a permanent restorative appliance. In such an example, the method and kit facilitate detection and complete removal of the adhesive, which may also reduce or eliminate the possibility that remaining adhesive will inadvertently remain adhered to the tooth surface, potentially leading to cracking of a fragile porcelain or composite permanent veneer or other appliance during attempted placement and bonding.

In another example, the method and kit are particularly useful when removing adhesive used to bond orthodontic appliances (e.g., orthodontic brackets) to a patient's teeth once the orthodontic treatment has been completed and it is necessary to remove the appliances and the adhesive used to bond the appliances. In such an example, the method, kit, and composition facilitate easier and more complete removal of the adhesive while minimizing or eliminating the removal of adjacent enamel.

In one aspect, the invention is directed to a pH sensitive color-changing temporary dental adhesive used for temporarily bonding a provisional dental restorative appliance to a tooth. Such a temporary adhesive is advantageously relatively weak so as to allow easy removal of a provisional appliance. According to an exemplary embodiment, a temporary dental adhesive may include at least one polymerizable component, a pH sensitive color-changing component, and a plasticizer and/or an un-reactive filler so as to reduce the bonding strength of the temporary dental adhesive to a value not greater than about 3 to 5 MPa. For example, the plasticizer and un-reactive filler may collectively comprise at least about 35%, more preferably at least about 40% by weight of the composition, which the inventors have found advantageously decreases bonding strength of the composition as compared to a composition in the absence of these components. For example, a plasticizer can act to reduce compressive and bonding strength as it weakens the cross-linked matrix structure of the polymerized resin. Un-reactive filler (e.g., a ceramic) may also act to increase compressive strength and/or decrease bonding strength as compared to a composition where all else is equal but without the un-reactive filler. In addition, an un-reactive filler may serve to reduce cost and provide a desired viscosity. Fumed ceramics (e.g., fumed silica) are particularly preferred for this purpose, as they modify the rheology of the composition and decrease bond strength with the addition of relatively small quantities (e.g., as compared to a ZEODENT filler material). For example, when using fumed ceramics rather than a ZEODENT un-reactive filler material, the plasticizer and fumed ceramic filler may collectively comprise at least about 25% by weight of the composition.

Such reduced bonding strength advantageously allows the practitioner to easily remove the temporary adhesive and provisional appliance in preparation for installing a permanent appliance. Inclusion of a pH sensitive color-changing component within the temporary adhesive composition allows the practitioner to apply an activating wash composition (e.g., an aqueous solution having a basic pH) once the appliance has been removed so as to highlight any temporary adhesive that remains adhered to the tooth surface. Upon application of the wash, the color changing component within the adhesive advantageously turns to a second color having higher contrast (e.g., turns to blue or red from colorless). Such highlighting renders the adhesive easily identifiable, facilitating its complete removal by the practitioner prior to positioning and bonding the permanent appliance. Of course, alternatively, the pH sensitive color-changing component could be included within the activating wash rather than the temporary adhesive composition.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1A illustrates a provisional veneer bonded to a tooth with a dental adhesive;

FIG. 1B illustrates the veneer of FIG. 1A being removed from the tooth such that adhering dental adhesive is seen still adhering to the tooth surface;

FIG. 1C illustrates the tooth surface with the dental adhesive once the veneer has been completely removed;

FIGS. 1D-1E illustrate an activating wash being applied to the tooth surface so as to cause a pH sensitive color changing component within either the adhesive or wash to change to a second higher contrast color so as to highlight the dental adhesive that remains adhered to the tooth surface;

FIG. 1F illustrates a dental burr being used to selectively remove the highlighted dental adhesive that remains adhered to the tooth surface;

FIG. 2A illustrates the tooth once all dental adhesive has been removed from the tooth surface;

FIG. 2B illustrates the permanent veneer bonded over the tooth surface;

FIG. 3A illustrates an orthodontic bracket being removed from a tooth, the tooth having orthodontic adhesive remaining adhered thereto;

FIG. 3B illustrates an activating wash being applied to the tooth surface so as to cause a pH sensitive color changing component within either the orthodontic adhesive or wash to change to a second higher contrast color so as to highlight the adhesive that remains adhered to the tooth surface;

FIG. 3C illustrates a dental burr being used to selectively remove the highlighted adhesive that remains adhered to the tooth surface; and

FIG. 3D illustrates the tooth once all orthodontic adhesive has been removed from the tooth surface.

### DETAILED DESCRIPTION OF THE PREFERRED EMBODIMENTS

### I. Introduction

The present invention is directed to methods, compositions, and kits for use in facilitating efficient removal of dental adhesives while minimizing and/or eliminating removal of adjacent tooth tissue (e.g., enamel). An inventive kit includes a curable dental adhesive composition including one or more polymerizable components and an activating wash composition. A pH sensitive color changing component (i.e., an acid/base indicator) is included within the adhesive or the activating wash. The adhesive composition is used to bond a dental appliance to a tooth. The dental appliance may comprise any restorative appliance (e.g., a veneer, a crown (e.g., a full crown, half-crown, three-quarters crown, seven-eights crown, or other crown), an inlay, an onlay, or other restorative appliance known in the art. In another embodiment, the appliance may comprise an orthodontic appliance (e.g., an orthodontic bracket) used during an orthodontic procedure. When it becomes necessary to remove the dental appliance, removal of all of the dental adhesive while minimizing and/or eliminating removal of enamel and/or other adjacent tooth tissue is minimized because of the inclusion of a pH sensitive color-changing component within the dental adhesive or activating wash composition.

### II. Exemplary Dental Adhesives

Exemplary dental adhesives include at least one polymerizable component, an initiator for initiating curing of the polymerizable component, and optionally a pH sensitive color-changing component (i.e., the pH sensitive color-changing component is included either within the adhesive or the activating wash). Such exemplary adhesive compositions may comprise a luting cement, an orthodontic adhesive used to bond an orthodontic appliance, a temporary cement used for temporarily bonding a provisional dental restorative appliance to a tooth, or any other adhesive used by a dental practitioner to bond a dental appliance to a tooth surface.

One example of such an adhesive is a temporary adhesive used for temporarily bonding a provisional veneer or other provisional restorative appliance to a tooth. Such a temporary adhesive is advantageously relatively weak so as to allow for easy removal of the provisional appliance. Such a temporary dental adhesive includes at least one polymerizable component, an initiator, and a plasticizer and/or an un-reactive filler so as to reduce the bonding strength of the temporary dental adhesive to a value not greater than about 5 MPa, more preferably not greater than 3 MPa, more preferably not greater than about 2.5 MPa, and most preferably not greater than about 2 MPa.

For example, the plasticizer and un-reactive filler may collectively comprise at least about 35%, more preferably at least about 40% by weight of the composition, which the inventors have found advantageously decreases bonding strength of the composition as compared to a composition not including these components. For example, a plasticizer acts to reduce bonding strength (also compressive strength) as it weakens the cross-linked matrix structure of the polymerized resin component(s). When present in sufficient quantities, an un-reactive filler (e.g., a ceramic) may also act to decrease bonding strength as compared to a composition where all else is equal but without the un-reactive filler.

In addition, an un-reactive filler may serve to increase compressive strength, reduce cost, and provide a desired viscosity or otherwise modify the rheology of the composition. For example, the addition of a fumed ceramic (e.g., filmed silica) results in a composition exhibiting Bingham fluid properties (i.e., applied force must exceed a critical yield stress in order to initiate flow), which decreases messiness and improves handleability of the composition. The fumed ceramic may be silanated to reduce the natural polarity of a fumed ceramic so as to increase homogeneity of the composition and also to facilitate a stronger bond between the fumed ceramic and the one or more polymerizable components. For example, when using fumed ceramics rather than a ZEODENT un-reactive filler material, the plasticizer and fumed ceramic filler may collectively comprise less of the composition while still providing a desired decreased bonding strength. For example, a fumed ceramic filler may comprise at least about 25% by weight of the composition while providing the desired low bonding strength for a temporary adhesive.

Such reduced bonding strength advantageously allows the practitioner to easily remove the provisional appliance in preparation for installing a permanent appliance. Inclusion of a pH sensitive color-changing component within either the temporary adhesive or an activating wash composition allows the practitioner to apply an activating wash composition (e.g., an aqueous solution having a particular selected pH configured to result in a color change of the pH sensitive color changing component) once the appliance has been removed so as to highlight any temporary adhesive that remains adhered to the tooth surface. Upon application of the wash, contact occurs between the color changing component and either the adhesive (if the color changing component is included within the wash) or the activating wash (if the color changing component is included within the adhesive). Contact results in a pH change of the environment of the color-changing component so as to cause a color change to occur. The result is that regions in which both the adhesive and the wash are present appear to change from a first, low contrast color to a second color providing greater contrast relative to adjacent tooth tissue (e.g., the adhesive turns to blue or red from colorless, white, or tooth colored).

Such highlighting renders the adhesive easily identifiable relative to adjacent tooth tissue, facilitating its complete and selective removal by the practitioner prior to positioning and bonding the permanent appliance. Advantageously, for aesthetic reasons, where the color-changing component is included within the adhesive, the pH sensitive color-changing component (and the overall dental adhesive) may be characterized as having a first color which provides little or no contrast relative to adjacent tooth tissue during normal use and absent application of an activating wash. Providing adhesives with such color-changing characteristics allows them to be both aesthetically appealing (i.e., providing little or no contrast) during normal use, and capable of changing to a high contrast color when needed to facilitate efficient and complete removal of the adhesive. Phenolphthalein and thymolphthalein are examples of such components which are colorless at relatively low pH values, and which change to red and blue, respectively, at a higher pH values (e.g., change to red occurs between about 8 and about 10 for phenolphthalein and change to blue occurs between about 9 and about 11 for thymolphthalein).

The pH sensitive color changing component included within either the dental adhesive composition or activating wash may comprise any suitable acid/base indicator. Exemplary acid/base indicators include phenolphthalein, thymolphthalein, and methyl orange. The pH sensitive color changing component is preferably included in an amount ranging from about 0.01% to about 3% by weight of the composition, more preferably between about 0.02% to about 2% by weight, and most preferably between about 0.05% and about 1% by weight of the composition.

Preferably, the acid/base indicator changes from a first color (e.g., colorless, white, or tooth-colored) having low contrast relative to adjacent tooth tissue to a second color (e.g., red, blue, yellow, green, orange, or purple) having a greater contrast relative to adjacent tooth tissue. Advantageously, the color change may occur within a pH range of about 7.5 to about 14, more preferably within a pH range of about 9 to about 13, and more preferably between about 10 and about 12. The preferred ranges are not acidic so as to prevent unnecessary etching or other damage to enamel and other hard tissues. The most preferred range (which corresponds to phenolphthalein and thymolphthalein) of about 10 to about 12 is advantageously not so strongly basic so as to cause irritation to adjacent soft tissues (e.g., the gingiva). It is further preferred that the acid/base indicator be non-carcinogenic. Although phenolphthalein may be used, thymolphthalein is particularly preferred as some believe there may be evidence that phenolphthalein may pose a carcinogenic risk. In addition, thymolphthalein changes from colorless to blue, which provides excellent contrast against tooth tissue, even if there is blood within the working area, while the red of phenolphthalein may be more difficult to readily identify as a result of normal pink or red tissue, as well as if there is blood near the working area.

Any polymerization initiator system may be used within the composition. For example, the adhesive may be a chemical cure or a light cure adhesive composition. Suitable photoinitiators may include IRGACURE (available from Ciba Specialty Chemicals) and/or camphorquinone. Other photoinitiators will be apparent to those skilled in the art. In one exemplary chemical cure two-part system, the initiator system includes an initiator (e.g., benzoyl peroxide or another peroxide) in a first part and a tertiary amine activator in a second part. Exemplary tertiary amines include 2,2-(p-Tolylimino)diethanol (P-TIDE), available from Sigma Aldrich, located in St. Louis, Mo., N, N-Dimethyl-p-toluidine (DMPT), or Ethyl 4-(Dimethylamino)Benzoate (EDMAB).

The initiator (e.g., either chemical or photo) is preferably included in an amount ranging from about 0.01% to about 3% by weight of the composition, more preferably between about 0.05% to about 2% by weight, and most preferably between about 0.1% and about 1% by weight of the composition. The amine activator component (in the case of chemical-cure initiated compositions) is preferably included in an amount ranging from about 0.01% to about 3% by weight of the composition, more preferably between about 0.05% to about 2% by weight, and most preferably between about 0.1% and about 1% by weight of the composition.

The composition includes at least one polymerizable component, examples of which include bisphenol-A glycidyl methacrylate (Bis-GMA), diurethane dimethacrylate (DUDMA), tri-ethylene glycol dimethacrylate (TEGDMA), hydroxyethyl methacrylate (HEMA), methacrylic acid, and/or glycerol di-methacrylate (GDMA), mono-2-(methacryloyloxy)ethyl succinate (HEMA Succinate), available from Sigma Aldrich, located in St. Louis, Mo.; and 1,2-benzenedicarboxylic acid mono(2-((2-methyl-1-oxo-2-propenyl)oxy)ethyl) ester phthalic acid 2-hydroxyethyl ester methacrylate (also known as 2-hydroxyethylmethacrylate/phthalic anhydride, available from Esstech, located in Essington, Pa. HEMA Succinate and 2-hydroxyethylmethacrylate/phthalic anhydride are examples of polymerizable components having a structure including at least one acrylate and/or methacrylate group at one end (e.g., a HEMA group) and a carboxylic acid group at another end. Such a molecule may have a linear structure so as to have just two ends, or it may be branched, so as to have more than two ends.

Mono-2-(methacryloyloxy)ethyl succinate has the structure shown below:

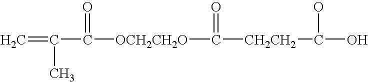

and 2-hydroxyethylmethacrylate/phthalic anhydride has the structure shown below:

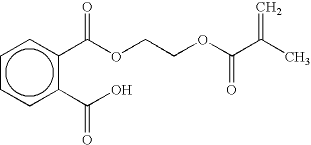

The inclusion of such a polymerizable component is particularly advantageous when the adhesive composition also includes zinc oxide, which reacts with the carboxylic acid group to form a solid zinc polycarboxylate matrix structure. In such a zinc polycarboxylate cement, the zinc oxide is preferably included in an amount ranging from about 3% to about 50% by weight, more preferably in an amount ranging from about 5% to about 30% by weight, and most preferably in an amount ranging from about 10% to about 20% by weight of the composition. Additional details of such adhesive compositions are disclosed in a United States Patent Application bearing attorney docket number 7678.1015, filed the same day as the present application and herein incorporated by reference.

The composition may advantageously include polymerizable components which may advantageously be capable of cross-linking during polymerization. Examples of such polymerizable components include various diacrylates and/or dimethacrylates, specific examples of which include Bis-GMA, DUDMA, TEGDMA, HEMA and/or GDMA. In addition, one or more of the polymerizable components may be phosphated so as to increase adhesion of the composition to tooth tissue. Cross-linking during polymerization results in increased overall bonding and compressive strength as compared to examples including no cross-linking polymerizable components. Because cross-linking polymerizable components tend to have relatively high viscosities, it may be advantageous to also include one or more non-cross-linking low viscosity polymerizable components (e.g., hydroxypropylmethacrylate—HPMA) that act as thinning agents so as to reduce the overall viscosity of the composition.

In one embodiment comprising a temporary adhesive composition, the adhesive is characterized by relatively low bonding strength as compared to permanent bonding adhesives. In some embodiments, compressive strength may also be reduced as compared to permanent bonding adhesives. Decreased bonding strength may be achieved through inclusion of a significant fraction of un-reactive filler and/or plasticizer within the composition. Un-reactive ceramic filler may actually increase compressive strength, while decreasing bonding strength. Plasticizers (e.g., a hydrocarbon such as polybutadiene or a polysorbate such as TWEEN-80) advantageously decrease bonding strength, and they may also act to decrease compressive strength.

Exemplary plasticizers include, but are not limited to glycerin, HERCOLYN-D, a hydrogenated methyl ester of rosin marketed by Hercules Chemical Company, aliphatic straight chain hydrocarbons such as polybutadiene, and/or TWEEN-80, a polysorbate. Because of their hydrophobic characteristics, an aliphatic hydrocarbon (e.g., polybutadiene) is particularly preferred as it minimizes absorption of saliva and/or water from within the mouth. Preferably any plasticizer is included in an amount ranging from about 15% to about 70% by weight of a temporary cement composition, more preferably between about 25% to about 60% by weight, and most preferably between about 30% and about 40% by weight of the temporary cement composition. In any case, the adhesive is advantageously substantially hydrophilic so as to prevent separation or repelling of the activating wash composition (which typically may be an aqueous and/or ethanol based hydrophilic liquid) when the activating wash is applied over the cured dental adhesive.

Exemplary un-reactive fillers include, but are not limited to ceramic fillers (e.g. any of various ceramic fillers sold under the trade name ZEODENT available from J. M. Huber Corporation). Preferably any un-reactive filler is included in an amount ranging from about 3% to about 30% by weight of the composition, more preferably between about 5% to about 25% by weight, and most preferably between about 7% and about 20% by weight of the composition. In one embodiment, the strength reducing plasticizer and/or un-reactive filler collectively comprise at least about 35% by weight of the composition, more preferably at least about 40% by weight of the composition. Another example of an unreactive filler is a fumed ceramic (e.g., fumed silica). For example, the addition of a fumed ceramic (e.g., fumed silica) results in a composition exhibiting Bingham fluid properties (i.e., applied force must exceed a critical yield stress in order to initiate flow), which decreases messiness and improves handleability of the composition. The fumed ceramic may be silanated to reduce the natural polarity of a fumed ceramic so as to increase homogeneity of the composition and also to facilitate a stronger bond between the fumed ceramic and the one or more polymerizable components. Examples of suitable fumed silica materials include various products sold under the trade name AEROSIL, available from Degussa AG. The fumed silica material may optionally be silanated.

Additional components, for example, colorants, flavorants, inhibitors (e.g., BHT), and other components may additionally be included. The inclusion of a colorant (e.g., a pigment and/or dye) within one or both parts of a two-part chemical cure adhesive composition (e.g., yellow within part 1 and blue within part 2) so as to give each part a color different from the other part is advantageous as it provides a visual indicator that the two parts have been homogeneously mixed together. Examples of suitable pigments include Suncroma yellow iron oxide, available from Sun Chemical located in Parsippany, N.J.; V-9117 deep tan, V-9115 buff, and 41130A blue spersastain, available from Ferro Corporation, located in Cleveland, Ohio. Additional colorants (e.g., dyes and/or pigments) will be apparent to one skilled in the art

### III. Exemplary Activating Wash Compositions

The inventive kits advantageously include an activating wash composition which either acts to effect a change in color of the pH sensitive color-changing component if the component is included within the dental adhesive, or which acts as a carrier for the pH sensitive color-changing component. The activating wash composition may comprise an acid or base aqueous solution as dictated by the pH sensitive color-changing component within the dental adhesive. Any suitable acid or base may be used (e.g., strong mineral acids, weak acids, or bases such as sodium hydroxide). For example, where the pH sensitive color-changing component comprises thymolphthalein, and the thymolphthalein is incorporated within the dental adhesive composition, the activating wash composition may be characterized as having a basic pH (e.g., within a range of about 9 to about 13, more preferably between about 10 to about 12), which corresponds to a pH range which will effect a color change of the thymolphthalein. One particularly preferred activating wash includes an acid or a base (e.g., NaOH), water, and ethanol.

In embodiments where the pH sensitive color-changing component (e.g., thymolphthalein) is included within the activating wash composition, the pH of the activating wash may advantageously be sufficiently low (e.g., less than about 10) so that the thymolphthalein is colorless (or nearly so) in that state. The adhesive composition may include a basic salt (e.g., sodium carbonate) or other component for raising the pH of the adhesive to a value (e.g., greater than about 9, typically between about 10 and about 12) that will result in the thymolphthalein changing from colorless or a slight blue tint to a bright blue when the activating wash composition contacts the cured adhesive.

### IV. Examples

### Example 1

An exemplary two-part chemical cure pH sensitive color-changing temporary cement composition including a pH sensitive color-changing component may be formed by mixing together equal weights of first and second parts as described below:

Part A:

| | |
|---|---|
| P-TIDE | 0.5% |
| BisGMA | 9.8% |
| DUDMA | 8% |
| Phenolphthalein | 0.2% |
| Zinc Oxide | 25% |
| Tween 80 | 55% |
| Fumed silica | 1.5% |

Part B:

| | |
|---|---|
| Benzoyl Peroxide | 0.5% |
| HEMA Succinate | 8% |
| ZEODENT 113 | 45% |
| TEGDMA | 8% |
| Water | 1.5% |
| Glycerin | 30% |
| GDMA (phosphated) | 7% |

### Example 2

An exemplary two-part pH sensitive color-changing temporary cement composition including a pH sensitive color-changing component may be formed by mixing together equal weights of first and second parts as described below:

Part A:

| | |
|---|---|
| P-TIDE | 0.5% |
| BisGMA | 9.8% |
| TEGDMA | 8% |
| Thymolphthalein | 0.2% |
| Zinc Oxide | 10% |
| Tween 80 | 70% |
| Fumed silica | 1.5% |

Part B:

| | |
|---|---|
| Benzoyl Peroxide | 0.5% |
| 2-hydroxyethylmethacrylate/phthalic anhydride | 10% |
| ZEODENT 113 | 37% |
| GDMA | 8% |
| HPMA | 10% |
| Water | 4.5% |
| HERCOLYN-D | 30% |

### Example 3

An exemplary two-part pH sensitive color-changing temporary cement composition was formed by mixing together equal weights of first and second parts as described below:

Part A:

| | |
|---|---|
| P-TIDE | 0.5% |
| BisGMA | 35% |
| TEGDMA | 15% |
| Zinc Oxide | 30% |
| ZEODENT 113 | 17.16% |
| Thymolphthalein | 0.2% |
| Suncroma yellow iron oxide pigment | 0.075% |
| V-9117 deep tan pigment | 0.05% |
| V-9115 buff pigment | 0.0125% |
| Fumed silica | 2% |

Part B:

| | |
|---|---|
| Benzoyl Peroxide | 0.4% |
| HEMA Succinate | 12% |
| GDMA (phosphated) | 2% |
| HPMA | 10% |
| Polybutadiene | 66.57% |
| Water | 0.5% |
| Fumed Silica | 7% |
| 41130A blue spersastain pigment | 0.035% |
| Almond oil flavorant | 1.5% |

The temporary cement composition was tested and found to have a compressive strength of about 17 MPa and a bonding strength of about 0.6 MPa. Compressive strength was measured by placing the mixed two-part composition into a cylindrical mold and allowed to cure. After curing, the sample was removed from the mold and sanded with sand paper to reduce the cylinder to a cylinder having dimensions of 2.15 mm in height and 2.35 mm in diameter. An INSTRON compressive strength measuring device was used to crush the sample so as to test compressive strength. Bonding strength was measured by performing a simulated “crown pull” test. The crown pull test was performed by shaping a human tooth into a conical shape. Using the cement composition to be tested, a corresponding metal simulated “crown” was cemented onto the tooth. The INSTRON device was used to pull the crown off the tooth so as to test bonding strength. The fracturing occurred within the cement composition (i.e., not at the interface between the simulated metal “crown” and the cement. In measuring both compressive and bonding strength, each test was performed multiple times and the results averaged. In addition, each sample was soaked in water for 24 hours before being broken.

### Example 4

An exemplary two-part temporary cement composition was formed by mixing together equal weights of first and second parts as described below:

Part A:

| | |
|---|---|
| P-TIDE | 0.5% |
| BisGMA | 34% |
| TEGDMA | 15% |
| Zinc Oxide | 29% |
| ZEODENT 113 | 18.8% |
| Thymolphthalein | 0.2% |
| Suncroma yellow iron oxide pigment | 0.075% |
| V-9117 deep tan pigment | 0.05 |
| V-9115 buff pigment | 0.0125 |
| Fumed silica | 2% |

Part B:

| | |
|---|---|
| Benzoyl Peroxide | 0.4% |
| HEMA Succinate | 12% |
| GDMA (phosphated) | 2% |
| HPMA | 10% |
| Polybutadiene | 56.57% |
| Cetyl Alcohol | 10% |
| Water | 0.5% |
| Fumed Silica | 7% |
| 41130A blue spersastain pigment | 0.035% |
| Almond oil flavorant | 1.5% |

The temporary cement composition was tested and found to have a compressive strength of about 29 MPa and a bonding strength of about 0.8 MPa. In measuring compressive strength and bonding strength, the same methology as described in conjunction with Example 3 was used.

### Example 5

An exemplary one-part photo-initiated temporary dental adhesive composition was formed by mixing together the components below:

| | |
|---|---|
| TEGDMA | 27.8% |
| GDMA (phosphated) | 6.62% |
| BisGMA | 29.12% |
| Thymolphthalein | 0.66% |
| IRGACURE 819 | 0.03% |
| Camphorquinone | 0.01% |
| 4-ethyl dimethylamino benzoate | 0.01% |
| Fumed silica | 6.62% |
| Fumed silica (silanated) | 23.83% |
| Polysorbate 80 | 1.32% |
| Methacrylic Acid | 3.97% |

The dental adhesive composition was tested and found to be suitable for use in temporarily adhering dental appliances to tooth surfaces.

### Example 6

An exemplary one-part photo-initiated dental adhesive composition was formed by mixing together the components below:

| | |
|---|---|
| TEGDMA | 27.8% |
| GDMA (phosphated) | 6.62% |
| BisGMA | 23.12% |
| Sodium carbonate | 6% |
| IRGACURE 819 | 0.03% |
| Camphorquinone | 0.01% |
| 4-ethyl dimethylamino benzoate | 0.01% |
| Fumed silica | 6.62% |
| Fumed silica (silanated) | 23.83% |
| Polysorbate 80 | 1.32% |
| Methacrylic Acid | 3.97% |

The dental adhesive composition was tested and found to be suitable for use in adhering dental appliances to tooth surfaces.

### Example 7

An exemplary activating wash composition was formed by mixing together the following components:

| | |
|---|---|
| Ethanol | 20% |
| Water | 79.7% |
| NaOH (1 N) | 0.3% |

The activating wash composition was found to have a pH of about 11.6. Upon application of the wash to the pH sensitive color-changing temporary dental adhesive composition of Example 3, the adhesive changed from a tooth-colored milky translucent white color to a bright blue color. The color change was reversible and repeatable (i.e., the adhesive returned to its original tooth-colored milky translucent white color after the activating wash composition was removed (e.g., by washing with water), and turned bright blue again upon reapplication of the activating wash composition.

### Example 8

An exemplary activating wash composition was formed by mixing together the following components:

| | |
|---|---|
| Ethanol | 40% |
| Water | 57.6% |
| NaOH (1 N) | 2.4% |

The activating wash composition was found to have a pH of about 13. Upon application of the wash to the pH sensitive color-changing temporary dental adhesive composition of Example 3, the adhesive changed from a tooth-colored milky translucent white color to a bright blue color. The color change was reversible and repeatable (i.e., the adhesive returned to its original tooth-colored milky translucent white color after the activating wash composition was removed (e.g., by washing with water), and turned bright blue again upon reapplication of the activating wash composition.

### Example 9

An exemplary activating wash composition was formed by mixing together the following components:

| | |
|---|---|
| Ethanol | 40% |
| Water | 58% |
| NaOH (1 N) | 2% |

The activating wash composition was found to have a pH of about 12.8-13. Upon application of the wash to the pH sensitive color-changing temporary dental adhesive composition of Example 3, the adhesive changed from a tooth-colored milky translucent white color to a bright blue color. The color change was reversible and repeatable (i.e., the adhesive returned to its original tooth-colored milky translucent white color after the activating wash composition was removed (e.g., by washing with water), and turned bright blue again upon reapplication of the activating wash composition.

### Example 10

An exemplary activating wash composition including a pH sensitive color-changing component was formed by mixing together the following components:

| | |
|---|---|
| Ethanol | 20% |
| Water | 79% |
| Thymolphthalein | 1% |
| NaOH (1 N) | 0.004% |

The activating wash composition was found to have a pH of about 9.5 and a slightly blue tint to the otherwise clear solution. Upon application of the wash to the pH sensitive color-changing temporary dental adhesive composition of Example 6, the adhesive appeared to change from a tooth-colored milky translucent white color to a bright blue color. The color change was reversible and repeatable (i.e., the adhesive returned to its original tooth-colored milky translucent white color after the activating wash composition was removed (e.g., by washing with water), and turned bright blue again upon reapplication of the activating wash composition.

### V. Exemplary Methods of Use

In an exemplary method according to the present invention, kits and/or dental adhesive compositions comprising a pH sensitive color-changing component may advantageously be employed so as to facilitate efficient and complete removal of the adhesive while minimizing or eliminating damage to adjacent tooth tissue (e.g., enamel).

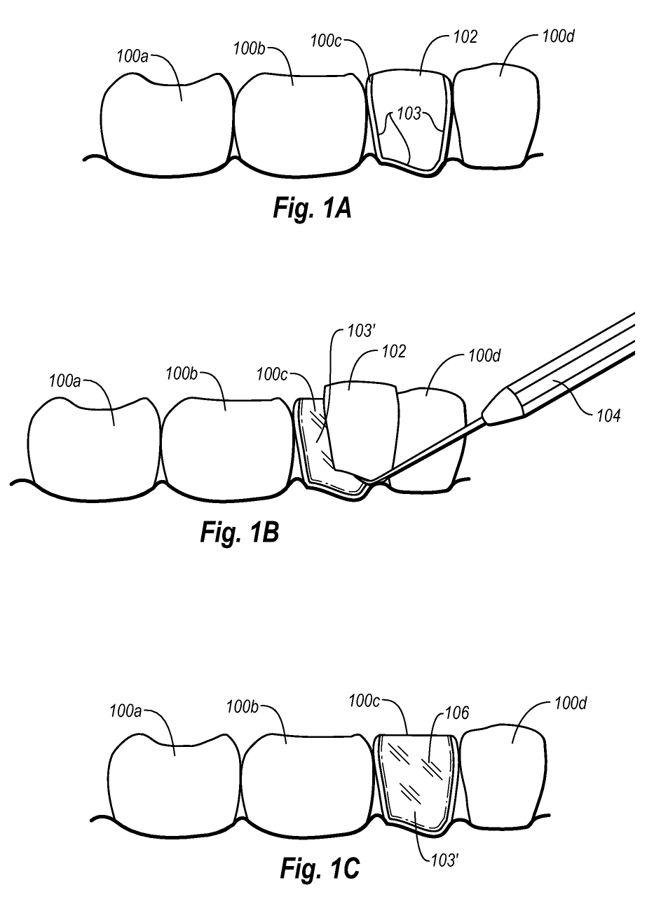

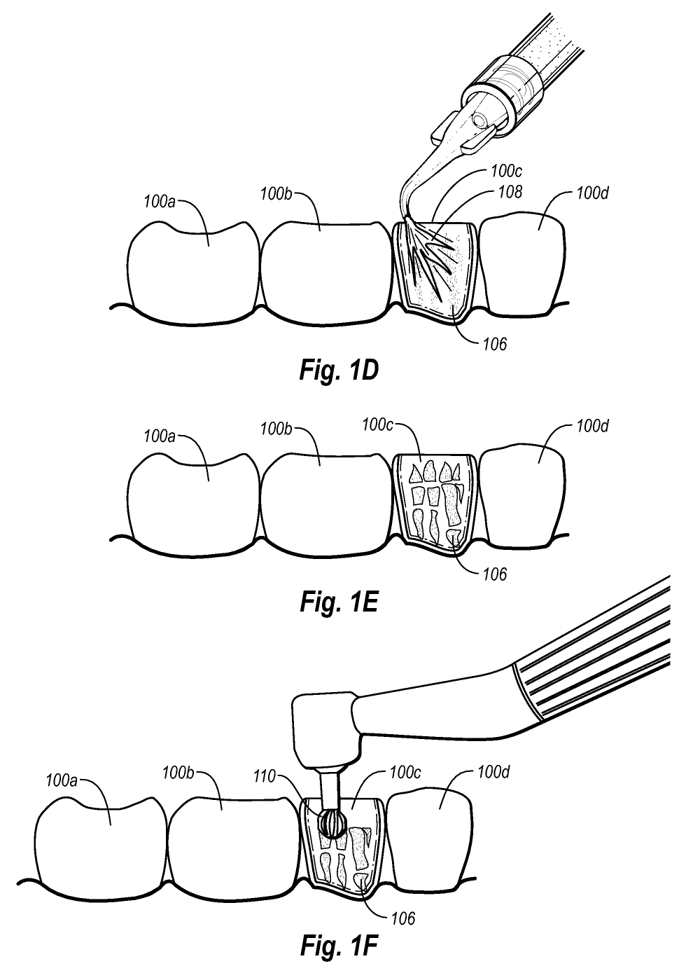

FIG. 1A illustrates a plurality of teeth 100a-100d, one of which (i.e., 100c) includes a provisional veneer 102 bonded to the labial surface thereof. Prior to bonding of provisional veneer 102, the tooth 100c is prepared as will be apparent to those skilled in the art. For example a thin layer (e.g., about 0.3 to about 0.5 mm) of the enamel surface and/or dentin may be removed from the labial surface of the tooth so that the labial central surface portion of the tooth is removed, leaving a recess into which the veneer may be bonded inconspicuously, hiding and/or minimizing visibility of the interface as much as possible. The interface 103 between natural tooth tissue and provisional veneer 102 is exaggerated for clarity purposes in the Figures.

Typically, the recessed portion is formed so that the interface at the bottom gingival edge lies as near to the gingiva as possible. Similarly, near the right and left sides of the tooth the recessed portion is formed so that the interface lies as close as possible to the edge defined by the maximum tooth width at any given location (e.g., each of the bottom, left, and right sides may be spaced back from their respective edge about 0.25 mm) so as to minimize visibility of the interface 103. In addition, in order to prevent visibility of any occlusal “top” interface, a portion of the occlusal tooth surface (e.g., 2-3 mm) may be removed so that the interface between the veneer and the natural tooth tissue is only visible from a lingual perspective. In forming the recessed portion it is important that the prepared labial surface be smooth so as to not present any raised portions or depressions relative to the smooth labial surface on which either the provisional veneer 102 or a later permanent veneer may crack when pressure is applied, which becomes particularly important when attempting to remove the adhesive used to bond the provisional veneer in preparation to placing a permanent veneer.

The provisional restorative appliance (e.g., veneer 102) may advantageously be installed over tooth 100c so as to provide an aesthetically acceptable appearance to the patient's teeth while a permanent veneer or other restorative appliance is prepared, which may typically take two weeks or more. Provisional veneer 102 may advantageously be bonded to tooth 100c with a dental adhesive (e.g., a temporary dental adhesive). Either the adhesive or an associated activating wash composition includes a pH sensitive color-changing component so as to facilitate fast, efficient, and complete removal of the cured adhesive when the provisional restorative appliance is replaced with a permanent appliance.

As shown in FIG. 1B, the provisional veneer 102 may be pried off tooth 100c with a suitable dental tool 104, exposing the recessed portion 103′ below. Using a temporary adhesive having a relatively low bonding strength (e.g., no more than about 3 to 5 MPa) advantageously allows for easy removal of veneer 102. Once provisional veneer 102 is removed, some dental adhesive 106 may remain adhered to the surface of tooth 100c (FIG. 1C).

Referring to FIG. 1D, in order to render dental adhesive 106 more easily visible and distinguishable from the adjacent tooth tissue, activating wash composition 108 is advantageously applied (e.g., by spraying or brushing) over the surface of tooth 100c and adhesive 106. A pH sensitive color-changing component is included within either the adhesive 106 or the activating wash composition 108. Upon contact of activating wash 108 with adhesive 106, the pH sensitive color-changing component (and by appearance, the adhesive 106) changes from a first color (e.g., tooth-colored, white, or colorless) having low contrast relative to the adjacent tissue of tooth 100c to a second color (e.g., red, blue, or other color contrasting with tooth 100c) having greater contrast relative to the background color provided by tooth 100c. For example, where the pH sensitive color-changing component comprises thymolphthalein, the remaining adhesive appears to change to a bright, easily distinguishable blue color.

In embodiments where the adhesive 106 comprises the pH sensitive color-changing component (e.g., thymolphthalein), the activating wash 108 is formulated so as to have a pH configured to cause the thymolphthalein or other pH sensitive color-changing component to change from a first color to a second color. In alternative embodiments where the wash 108 comprises the pH sensitive color-changing component (e.g., thymolphthalein), the adhesive 106 advantageously is formulated so as to have a pH configured to cause the thymolphthalein or other pH sensitive color-changing component to change from a first color to a second color. Only the adhesive appears to change color (even though the wash with its pH sensitive color changing component may be present elsewhere within the patient's mouth) because the color change only occurs where both the adhesive and wash composition are present. The adhesive provides a pH configured to cause the color change to occur. For this reason, it is important in such an embodiment that the color-change occur in a pH range not normally present within the oral cavity. In other words, the saliva within the oral cavity is typically near neutral pH, and so the color-changing component is advantageously selected so that the color change to the second, higher contrast color occurs either at a somewhat acidic pH (e.g., between about 3.5 to about 6), or at a basic pH (e.g., between about 7.5 and about 14, more preferably between about 9 and about 13, most preferably between about 10 and about 12).

Because the one or more polymerizable components included within the polymerizable adhesives often provide the adhesive composition with a somewhat acidic pH, it may be necessary for the adhesive to incorporate a component (e.g., a basic salt such as sodium carbonate) configured to alter the pH of the cured adhesive so that when the activating wash contacts the adhesive, the thymolphthalein or other pH sensitive color-changing component changes from a first color (e.g., colorless in the case of thymolphthalein) to a second color (e.g., blue in the case of thymolphthalein). It will be understood that where the selected pH sensitive color-changing component changes to a second color having greater contrast upon exposure to an acidic pH, no additional component for modifying the pH of the cured adhesive may be necessary.

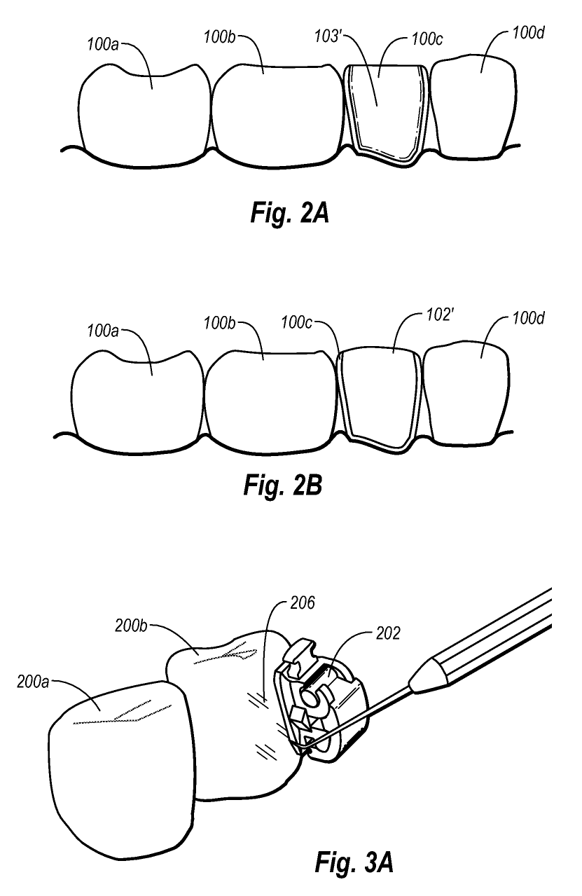

As shown in FIGS. 1E-1F, the highlighted adhesive 106 may be selectively removed by use of a dental burr 110 or other suitable tool. Because the remaining adhesive is colored so as to contrast against the adjacent tooth tissue, the practitioner is easily able to direct tool 110 so as to remove only the adhesive 106, so as to minimize and/or eliminate any damage to adjacent enamel or other tooth tissue. In addition, because of the high contrast coloring of the dental adhesive 106, the practitioner is easily able to determine when all adhesive 106 has been removed, i.e., removal of adhesive 106 is advantageously complete, leaving a clean recessed surface 103′ as shown in FIG. 2A. Permanent veneer 102′ may then be bonded over tooth 100c (FIG. 2B), filling in the recessed portion 103′ formed within the labial surface of tooth 100c. Because removal of adhesive 106 is complete (i.e., all substantial traces of adhesive 106 are removed), the risk of permanent veneer 102′ cracking or otherwise being damaged as a result of an uneven, bumpy underlying surface caused by remaining adhered adhesive 106 is minimized and/or eliminated.

Although illustrated in conjunction with a veneer, it will be appreciated that the dental restorative appliance may comprise other types of appliances, for example, any type crown (e.g., full crown, half crown, quarter crown, three-quarters crown, seven-eighths crown), an inlay, or an onlay.

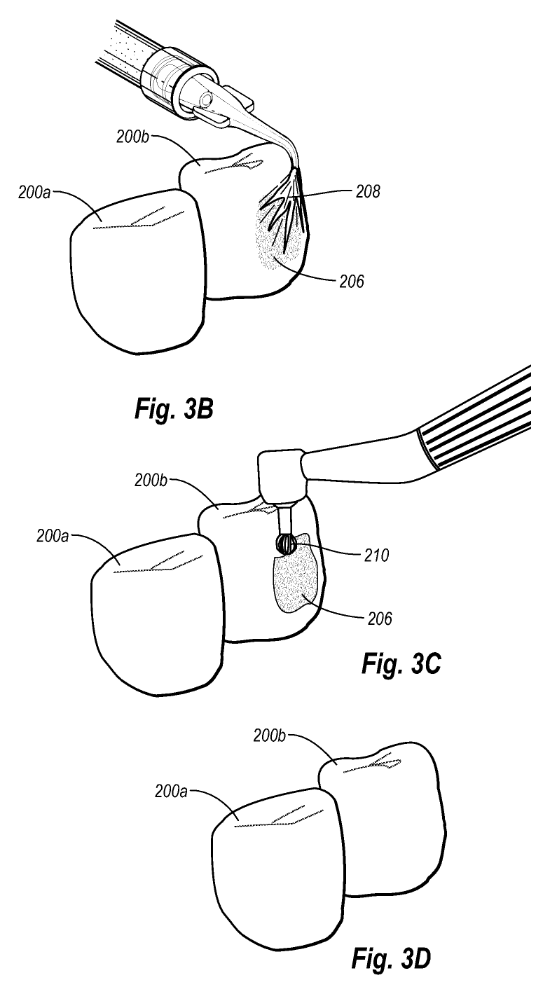

FIGS. 3A-3D illustrate another exemplary method according to the present invention in which the methods, kits, and compositions are used in bonding and removing an orthodontic bracket from a tooth surface. Incorporation of a pH sensitive color-changing component within either the dental adhesive or the activating wash facilitates efficient and complete removal of the adhesive while minimizing removal of adjacent tooth tissue (e.g., enamel) once the orthodontic treatment is complete. FIG. 3A illustrates a plurality of teeth 200a-200b and an orthodontic bracket 202 being removed from tooth 200b. As seen, a quantity of cured orthodontic adhesive 206 remains adhered to tooth 200b. In the illustrated example, thymolphthalein or another pH sensitive color changing component may be incorporated within adhesive 206. As shown in FIG. 3B, application of an activating wash 208 (e.g., an aqueous solution having a pH between about 10 and about 12) causes the thymolphthalein or another a pH sensitive color-changing component within adhesive 206 to change from a first color (e.g., colorless in the case of thymolphthalein) having low contrast relative to tooth 200b to a second color (e.g., blue in the case of thymolphthalein) having greater contrast relative to tooth 200b so as to highlight dental adhesive 206 that remains adhered to tooth 200b.

As shown in FIG. 3C-3D, a dental burr 210 or other suitable tool may be used to selectively remove the highlighted cured adhesive 206 that remains adhered to tooth 200b. Because the remaining adhesive 206 is colored so as to contrast against the adjacent tissue of tooth 200b, the practitioner is easily able to direct tool 210 so as to selectively and preferentially remove only the adhesive 206, so as to minimize and/or eliminate any damage to adjacent enamel or other tooth tissue, resulting in clean, strong, and healthy teeth as shown in FIG. 3D.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for increasing visual contrast of a dental adhesive that remains adhered to tooth tissue so as to facilitate detection and removal of remaining adhesive, comprising:
providing a tooth including a cured dental adhesive adhered thereto; and
applying an activating wash composition to the tooth and the cured dental adhesive, wherein the dental adhesive or the activating wash composition includes a pH sensitive color changing component such that upon contact of the activating wash with the dental adhesive, the pH sensitive color changing component changes from a first color having low contrast relative to adjacent tooth tissue to a second color having a higher contrast relative to adjacent tooth tissue so as to highlight the remaining dental adhesive.

2. A method as recited in claim 1, wherein the pH sensitive color changing component is included within the dental adhesive.

3. A method as recited in claim 1, wherein the pH sensitive color changing component is included within the activating wash composition.

4. A method as recited in claim 1, further comprising removing the remaining dental adhesive from the tooth.

5. A method as recited in claim 4, wherein the dental adhesive comprises a temporary dental adhesive that includes at least one of a plasticizer and/or an un-reactive filler that reduces bonding strength compared to composition lacking such components.

6. A method as recited in claim 4, further comprising bonding a permanent dental restorative appliance to the tooth subsequent to removing the remaining temporary dental adhesive.

7. A method as recited in claim 6, wherein the permanent dental restorative appliance comprises a veneer or crown.

8. A method as recited in claim 1, wherein the activating wash composition has a pH between about 9 and about 13.

9. A method as recited in claim 1, wherein the activating wash composition has a pH between about 10 and about 11.

10. A method as recited in claim 1, wherein the pH sensitive color changing component comprises thymolphthalein.

11. A pH sensitive color changing temporary dental adhesive composition comprising:
a polymerizable component;
at least one of a plasticizer and/or an un-reactive filler so as to reduce a bonding strength of the temporary dental adhesive composition to a value not greater than about 5 MPa; and
a pH sensitive color changing component, the pH sensitive color changing component changing from a first color having low contrast relative to adjacent tooth tissue to a second color having a higher contrast relative to adjacent tooth tissue upon application of an activating wash composition.

12. A pH sensitive color changing temporary dental adhesive composition as recited in claim 11, wherein the pH sensitive color changing component comprises an acid or base indicator.

13. A pH sensitive color changing temporary dental adhesive composition as recited in claim 11, wherein the pH sensitive color changing component comprises thymolphthalein.

14. A pH sensitive color changing temporary dental adhesive composition as recited in claim 11, wherein the bonding strength of the temporary dental adhesive composition is not greater than about 2.5 MPa.

15. A pH sensitive color changing temporary dental adhesive composition as recited in claim 11, wherein the pH sensitive color changing component comprises between about 0.01 percent and about 3 percent by weight of the composition.

16. A pH sensitive color changing temporary dental adhesive composition as recited in claim 11, wherein the pH sensitive color changing component comprises between about 0.02 percent and about 2 percent by weight of the composition.

17. A pH sensitive color changing temporary dental adhesive composition as recited in claim 11, wherein the pH sensitive color changing component comprises between about 0.05 percent and about 1 percent by weight of the composition.

18. A pH sensitive color changing temporary dental adhesive composition as recited in claim 11, wherein the temporary dental adhesive composition is provided in two parts.

19. A pH sensitive color changing temporary dental adhesive composition as recited in claim 11, wherein the plasticizer and/or un-reactive filler collectively comprise at least about 35% by weight of the temporary dental adhesive composition.

20. A pH sensitive color changing dental adhesive composition comprising:
a polymerizable component; and
a pH sensitive color changing component, the pH sensitive color changing component changing from a first color having low contrast relative to adjacent tooth tissue to a second color having a higher contrast relative to adjacent tooth tissue upon application of an activating wash composition so as to highlight cured dental adhesive that remains adhered to a tooth surface, the pH sensitive color-changing component comprising thymolphthalein.

21. A kit for use in increasing the visual contrast of dental adhesive that remains adhered to a tooth tissue substrate so as to facilitate detection and removal of remaining dental adhesive comprising:
a curable dental adhesive composition comprising a polymerizable component; and
an activating wash composition;
wherein the dental adhesive composition or the activating wash composition includes a pH sensitive color changing component, the pH sensitive color changing component changing from a first color having low contrast relative to adjacent tooth tissue to a second color having a higher contrast relative to adjacent tooth tissue upon application of the activating wash composition so as to highlight cured dental adhesive that remains adhered to a tooth surface.

22. A kit as recited in claim 21, wherein the pH sensitive color changing component is included within the dental adhesive composition.

23. A kit as recited in claim 22, wherein the activating wash composition has a pH between about 9 and about 13.

24. A kit as recited in claim 22, wherein the activating wash composition has a pH between about 10 and about 12.

25. A kit as recited in claim 21, wherein the pH sensitive color changing component is included within the activating wash composition.

26. A kit as recited in claim 25, wherein the dental adhesive composition provides a pH corresponding to a pH at which the pH sensitive color changing component changes from a first color to a second color.

27. A kit as recited in claim 26, wherein the dental adhesive composition provides a pH between about 10 and about 12.

28. A kit as recited in claim 26, wherein the dental adhesive composition comprises a salt configured to provide a pH so as to effect a change in color of the pH sensitive color-changing component from a first color to a second color.

29. A kit as recited in claim 28, wherein the salt comprises sodium carbonate.

30. A kit as recited in claim 21, wherein the pH sensitive color changing component comprises thymolphthalein.
